(19) United States
(12) Patent Application Publication
(10) Pub. No.: US 2021/0130190 A1
(43) Pub. Date: May 6, 2021

(54) DOPED LITHIUM POSITIVE ELECTRODE ACTIVE MATERIAL AND PROCESS FOR MANUFACTURE THEREOF

(71) Applicant: HALDOR TOPSØE A/S, Kgs. Lyngby (DK)

(72) Inventors: Jonathan HØJBERG, Kgs. Lyngby (DK); Søren DAHL, Hillerød (DK); Jakob Weiland HØJ, Gentofte (DK); Christian Fink ELKJÆR, Birkerød (DK)

(73) Assignee: HALDOR TOPSØE A/S, Kgs. Lyngby (DK)

(21) Appl. No.: 17/041,834

(22) PCT Filed: May 6, 2019
(86) PCT No.: PCT/EP2019/061544

§ 371 Date: Sep. 25, 2020

(30) Foreign Application Priority Data
May 9, 2018 (DK) PA 2018 00206

(51) Int. Cl. C01G 53/00

(52) U.S. Cl. CPC C01G 53/54; C01P 2004/61; C01P 2002/54; C01P 2006/11; C01P 2002/32; C01P 2006/12

(57) ABSTRACT

The invention relates to a lithium positive electrode active material for a high voltage secondary battery, where the cathode is fully or partially operated above 4.4 V vs. Li/Li+. The lithium positive electrode active material comprises at least 95 wt % spinel having a chemical composition of LiₓNi_{y}Mn_{2-y-z}D_{z}O₄, wherein 0.9≤x≤1.1, 0.4≤y≤0.5, 0.02≤z≤0.2, wherein D is a dopant chosen between the following elements: Co, Cu, Ti, Zn, Mg, Fe or combinations thereof. The lithium positive electrode active material is a powder composed of secondary particles formed by primary particles, wherein said lithium positive electrode active material has a tap density of at least 1.9 g/cm³. The invention also relates to process for preparing the lithium positive electrode active material of the invention and a secondary battery comprising the lithium positive electrode active material of the invention.

### FIELD OF THE INVENTION

Embodiments of the invention generally relate to a lithium positive electrode active material, to a process for preparing a lithium positive electrode active material and to a secondary battery comprising the lithium positive electrode active material.

### BACKGROUND

Developing high energy density rechargeable battery materials have become a major research topic due to their broad applications in electric vehicles, portable electronics and grid-scale energy storage. Since their first commercialization in the early 1990s, Li-ion batteries (LIBs) present many advantages with respect to other commercial battery technologies. In particular, their higher specific energy and specific power make LIBs the best candidate for electric mobile transport application.

It is an object of the present invention to provide a lithium positive electrode active material having high operating potential, low degradation and maintaining high capacity.

### SUMMARY OF THE INVENTION

Embodiments of the invention generally relate to a lithium positive electrode active material, to a process for preparing a lithium positive electrode active material and to a secondary battery comprising the lithium positive electrode active material.

One aspect of the invention relates to a lithium positive electrode active material for a high voltage secondary battery, where the cathode is fully or partially operated above 4.4 V vs. Li/Li+, where the lithium positive electrode active material comprises at least 95 wt % spinel having a chemical composition of LiₓNi_{y}Mn_{2-y-z}D_{z}O₄, wherein 0.9≤x≤1.1, 0.4≤y≤0.5, 0.02≤z≤0.2, and wherein D is a dopant chosen between the following elements: Co, Cu, Ti, Zn, Mg, Fe or combinations thereof. The lithium positive electrode active material is a powder composed of secondary particles formed by a dense agglomerate of primary particles, and the lithium positive electrode active material has a tap density of at least 1.9 g/cm³. The effect of the doping is to stabilize the material so that it is less prone to capacity degradation as a function of charge/discharge cycles. In the material of the invention, the amount of the doping has been kept relatively low in order to keep the capacity of the material substantially unchanged compared to an undoped material, and at the same time obtaining the stabilizing effect of the dopant, viz. decreasing the degradation of the lithium positive electrode active material. The formula indicated above for the material of the invention is a net chemical formula. The dopant may be distributed within the bulk of the lithium positive electrode active material, on the surface thereof, with a gradient concentration or any other appropriate distribution. However, in an embodiment the dopant is distributed substantially uniformly throughout the lithium positive electrode active material, viz. distributed substantially uniformly throughout the primary particles and thus also uniformly throughout the secondary particles.

Preferable values of y lie in the range from 0.43 to 0.49, and even more preferably values of y lie in the range from 0.45 to 0.47, in that these values of y provide an advantageous compromise between Ni activity, which increases with increased values of y, and the risk of cation ordering the lithium positive electrode active material, which risk decreases with increased values of y.

The net chemical composition is a composition for all the lithium positive electrode active material. Thus, the lithium positive electrode active material may comprise impurities having another formula than LiₓNi_{y}Mn_{2-y-z}D_{z}O₄, wherein 0.9≤x≤1.1, 0.4≤y≤0.5, 0.02≤z≤0.2, and wherein D is a dopant chosen between the following elements: Co, Cu, Ti, Zn, Mg, Fe. A formula for the net chemical composition covering all the lithium positive electrode active material may be written as: LiₓNi_{y}Mn_{2-y-z}D_{z}O_{4-δ}, −(0.5−y)<δ<0.1, wherein 0.9≤x≤1.1, 0.4≤y≤1.5, 0.02≤z≤0.2, and wherein D is a dopant chosen between the following elements: Co, Cu, Ti, Zn, Mg, Fe.

In an embodiment 0.96×1.0 in the composition LiₓNi_{y}Mn_{2-y-z}D_{z}O₄. When 0.96≤x≤1.0, the amount z of the dopant D is in the lower end of the interval 0.02≤z≤0.2. This corresponds to an amount of dopant D providing an increased degradation and also a low decrease in discharge capacity of the lithium positive electrode active material.

There seems to be a synergy effect between the dense lithium positive electrode active material of the invention and the stability enhancing effect of doping, so that the material of the invention is particularly stable during discharge-charge cycling.

The term “tap density” is used to describe the bulk density of a powder (or granular solid) after consolidation/compression prescribed in terms of ‘tapping’ the container of powder a measured number of times, usually from a predetermined height. The method of ‘tapping’ is best described as ‘lifting and dropping’. Tapping in this context is not to be confused with tamping, side-ways hitting or vibration. The method of measurement may affect the tap density value and therefore the same method should be used when comparing tap densities of different materials. The tap densities of the present invention are measured by weighing a measuring cylinder before and after addition of at least 10 g of powder to note the mass of added material, then tapping the cylinder on the table for some time and then reading of the volume of the tapped material. Typically, the tapping should continue until further tapping would not provide any further change in volume. As an example only, the tapping may be about 120 or 180 times, carried out during a minute.

The tap density is preferably equal to or greater than 2.0 g/cm³; equal to or greater than 2.2 g/cm³; equal to or greater than 2.4 g/cm³; or equal to or greater than 2.6 g/cm³. A higher tap density provides possibility to obtain higher volumetric electrode loading and thus a higher volumetric energy density of batteries containing materials with a high tap density. For most battery applications, space is at a premium, and high energy density is desired. Powders of the electrode material with a high tap density tend to result in electrodes with higher active material loading (and thus higher energy density) than powders with a low tap density. It can be shown using geometry-based arguments that materials composed of spherical particles have a higher theoretical tap density than particles with irregular shapes.

The specific capacity of the lithium positive electrode active material of the invention decreases by no more than 2-3% over 100 charge-discharge cycles between 3.5 V and 5.0 V when cycled at 55° C. as described in example 1.

When the dopant D is e.g. Co, the dopant assists in reducing the degradation of the lithium positive electrode active material. Often doping of a lithium positive electrode active material with a stabilizing dopant reduces the capacity of the lithium positive electrode active material; however, when the amount of the dopant is reduced this reduction in the overall capacity of the lithium positive electrode active material is also reduced. Thereby, the capacity fading during cycling is reduced by the material of the invention compared to a similar LNMO material without doping (viz. z=0 in the formula above), whilst the capacity of the lithium positive electrode active material is close to the capacity of the similar LNMO material. In total the capacity fading at room temperature and at 55° C. is less than 2% per 100 cycles when measured as described in Example 1 with the lithium positive electrode active material of the invention. The undoped LNMO material is a dense LNMO material, in terms of tap density, which seem to be essential to obtain the good performance of the lithium positive electrode active material of the invention. It should be noted that the materials “LNMO material” and “LMNO material” are examples of a lithium positive electrode active material.

The lithium positive electrode active material of the invention has been shown to have decreased sloping voltage curve between 4.2 V and 4.4 V. The sloping voltage curve and the capacity between 4.2 V and 4.4 V is seen in FIGS. 7 and 8, respectively.

This homogeneous or uniform doping of the lithium positive electrode active material does not substantially compromise the electrochemical performance of the material but acts as a stability enhancer. This means that the power capability and the electrochemistry, such as redox activity, of the doped lithium positive electrode active material are essentially unchanged; however, the capacity may be slightly reduced, compared to a similar, but undoped lithium positive electrode active material. Both the doped and undoped LMNO materials present good charge/discharge capacity, also when used in full Li-ion cells versus graphite anodes. However, cells using the doped LMNO material present reduced degradation in comparison to LMNO material without dopant.

In an embodiment at least 90% of the dopant D is incorporated within the spinel of the lithium positive electrode material. When the dopant D is primarily incorporated within the spinel of the lithium positive electrode material, the effect of doping the lithium positive electrode material with a dopant D is utilized optimally. Therefore, this provides for a high energy density of the lithium positive electrode material.

In an embodiment, the lithium positive electrode active material is cation disordered. This means that the lithium positive electrode active material is a disordered space group, e.g. Fd-3m. A disordered material has the advantage of having high stability in terms of low fade rate.

The symmetry of the spinel lattice is described by space groups of P4₃32 for the cation ordered phase and Fd-3m for the cation disordered phase with a lattice constant a at around 8.2 Å. Spinel material may be a single disordered or ordered phase, or a mix of both. Adv. Mater. (2012) 24, pp 2109-2116.

In an embodiment, BET surface area of the secondary particles is below 0.25 m²/g. The BET surface may be down to about 0.15 m²/g. It is advantageous that the BET surface area is low since a low BET surface area correspond to a dense material with a low porosity. Since degradation reactions occur on the surface of the material, such a material typically is a stable material. The undoped LNMO material is a low surface LNMO material, in terms of BET surface area, which is advantageous to obtain the good performance of the lithium positive electrode active material of the invention. The doped LNMO material retain the stable characteristics of the undoped LNMO material and is improved further in relation to stability during charge/discharge.

In an embodiment, the secondary particles are characterized by an average circularity higher than 0.55 and simultaneously an average aspect ratio lower than 1.60. Preferably, the average aspect ratio is lower than 1.5 and more preferably below 1.4 whilst the average circularity is higher than 0.65 and more preferably higher than 0.7. There are several ways to characterize and quantify the circularity or sphericity and shape of particles. Almeida-Prieto et al. in J. Pharmaceutical Sci., 93 (2004) 621, lists a number of form factors that have been proposed in the literature for the evaluation of sphericity: Heywood factors, aspect ratio, roughness, pellips, rectang, modelx, elongation, circularity, roundness, and the Vp and Vr factors proposed in the paper. Circularity of a particle is defined as 4·π·(Area)/(Perimeter)², where the area is the projected area of the particle. An ideal spherical particle will thus have a circularity of 1, while particles with other shapes will have circularity values between 0 and 1. Particle shape can further be characterized using aspect ratio, defined as the ratio of particle length to particle breadth, where length is the maximum distance between two points on the perimeter and breadth is the maximum distance between two perimeter points linked by a line perpendicular to length.

The advantage of a material with a circularity above 0.55 and an aspect ratio below 1.60 is the stability of the material due to the low surface area thereof. As seen in FIG. 9a, a circularity of about 0.6 or higher provides for a low degradation in itself; the doping with dopant D assists in further lowering the degradation of the lithium positive electrode active material. Thus, the circularity of the secondary particles and the doping of the lithium positive electrode active material provide a synergy effect in relation to decreasing the degradation of the lithium positive electrode active material.

The shape and size of the secondary particles were measured in 9 SEM images using the software ImageJ. Particles were identified by setting a threshold and creating a binary image, followed by use of the watershed algorithm to separate touching particles. Only particles where the entire rim was visible were measured, i.e. a particle lying underneath another particle in a SEM image was excluded from the analysis. A circle circumscribing each of the measured secondary particle is fitted along the perimeter thereof. The perimeter of this fitted circle is influenced by the primary particles making up the secondary particle, so that if the primary particles are fitted closely together, the size of the perimeter is smaller than a case with relatively more loosely fitted primary particles and/or primary particles extending in different directions.

In an embodiment, D50 of the secondary particles is between 3 and 50 μm, preferably between 3 and 25 μm. This is advantageous in that such particle sizes enable easy powder handling and low surface area, while maintaining sufficient surface to transport lithium in and out of the structure during discharge and charge.

One way to quantify the size of particles in a slurry or a powder is to measure the size of a large number of particles and calculate the characteristic particle size as a weighted mean of all measurements. Another way to characterize the size of particles is to plot the entire particle size distribution, i.e. the volume fraction of particles with a certain size as a function of the particle size. In such a distribution, D5 and D10, respectively, are defined as the particle size where 5% and 10%, respectively, of the population lies below the value of D10, D50 is defined as the particle size where 50% of the population lies below the value of D50 (i.e. the median), and D90 is defined as the particle size where 90% of the population lies below the value of D90. Commonly used methods for determining particle size distributions include laser diffraction measurements and scanning electron microscopy measurements, coupled with image analysis.

In an embodiment, the distribution of the agglomerate size of the secondary particles is characterized in that the ratio between D90 and D10 is smaller than or equal to 4. This corresponds to a narrow size distribution. Such a narrow size distribution, preferably in combination with D50 of the secondary particles being between 3 and 50 μm, indicates that the lithium positive electrode material has a low number of fines and thus a low surface area. In addition, a narrow particle size distribution ensures the electrochemical response of all the secondary particles of the lithium positive electrode material will be essentially the same so that stressing a fraction of the particles more than the rest is avoided.

In an embodiment, the diameter or the volume equivalent diameter of the primary particles, except from D5 primary particles, is between 100 nm and 2 μm and the diameter or the volume equivalent diameter of the secondary particles, except from D5 secondary particles, is between 1 μm and 25 μm. The term “except from D5 particles” is meant to denote that the finest particles are not taken into consideration.

The values of volume equivalent diameter of the primary particles are as measured by SEM or Rietveld refinement of XRD measurements. An average diameter or average volume equivalent diameter of the primary particles is e.g. about 250 nm based upon Rietveld refinement of XRD measurements, and an average diameter or average volume equivalent diameter of the secondary particles is between 10 and 15 μm. As used herein, the term “volume equivalent diameter” of an irregularly shaped object is the diameter of a sphere of equivalent volume.

In an embodiment, at least 90% of the dopant D is part of the spinel. Being part of the spinel means that the atoms of the dopant D take the place of elements that were in the crystal lattice or crystal structure of the lithium positive electrode material.

In an embodiment, the capacity of the lithium positive electrode active material is above 120 mAh/g. This is measured at least at a discharge current of 30 mA/g. Preferably the capacity of the lithium positive electrode active material is above 130 mAh/g at a current of 30 mA/g. Discharge capacities and discharge currents in this document are stated as specific values based on the mass of the active material.

In an embodiment, the separation between the two Ni-plateaus around 4.7 V of the lithium positive electrode active material is at least 50 mV. A preferred value of the plateau separation is about 60 mV. The plateau separation is a measure of the energies related to insertion and removal of lithium at a given state of charge and this is influenced by the choice and amount of dopant and whether the spinel phase is disordered or ordered. Without being bound by theory, a plateau separation of at least 50 mV seems advantageous since this occurs to be related to whether the lithium positive electrode active material is in an ordered or a disordered phase. The plateau separation is e.g. 60 mV, and a maximum value is about 100 mV.

Another aspect of the invention relates to a process for preparing a lithium positive electrode active material comprising at least 95 wt % spinel having a chemical composition of LiₓNi_{y}Mn_{2-y-z}D_{z}O₄, wherein 0.9≤x≤1.1, 0.4≤y≤0.5, 0.02≤z≤0.2, wherein D is a dopants chosen between the following elements: Co, Cu, Ti, Zn, Mg, Fe or combinations thereof, wherein the lithium positive electrode active material is composed of particles, wherein said lithium positive electrode active material has a tap density of at least 1.9 g/cm³ and wherein said lithium positive electrode active material comprises at least 95 wt % spinel phase. The process comprises the steps of:

a) providing a lithium positive electrode active material comprising at least 95 wt % spinel having a chemical composition of LiₓNi_{y}Mn_{2-y}O₄, wherein 0.9≤x≤1.1 and 0.4≤y≤0.5,

b) mixing the lithium positive electrode active material of step a) with a dopant precursor of the dopant D,

c) heating the mixture of step b) to a temperature of between 600° C. and 1000° C.

Thus, the lithium positive electrode active material is manufactured by a post-treatment of a LNMO material having the formula LiₓNi_{y}Mn_{2-y}O₄, wherein 0.9≤x≤1.1 and 0.4≤y≤0.5 and having a tap density of at least 1.9 g/cm³ comprising at least 95 wt % spinel phase. Hereby, the advantages of the dense LMNO material are maintained whilst the stability enhancing properties of the dopant are added. The amount of dopant is chosen so that the effects of the stability enhancement due to adding the dopant and the capacity loss incurred by the addition of a dopant are balanced.

The temperature of step c) is preferably between 700° C. and 900° C., such as 750° C.

In an embodiment, the temperature of step c) and the duration in time of step c) are controlled so as to ensure uniform distribution of the dopant D throughout the lithium positive electrode material. For relatively short durations of time of step c) the temperature of step c) should be relatively higher, whilst for relatively long durations of time of step c) the temperature of step c) should be relatively lower. An example is that the temperature is about 750° C. and the duration of time is 4 hours.

Another aspect of the invention relates to a process for preparing a lithium positive electrode active material comprising at least 95 wt % spinel having a chemical composition of LiₓNi_{y}Mn_{2-y-z}D_{z}O₄, wherein 0.9≤x≤1.1, 0.4≤y≤0.5, and 0.02≤z≤0.2, wherein D is a dopant chosen between the following elements: Co, Cu, Ti, Zn, Mg, Fe or combinations thereof, wherein the lithium positive electrode active material is composed of particles, wherein the lithium positive electrode active material has a tap density of at least 1.9 g/cm³ and wherein the lithium positive electrode active material comprises at least 95 wt % spinel phase. The process comprises the steps of:

a) providing precursors for preparing a lithium positive electrode active material comprising at least 95 wt % spinel having a chemical composition of LiₓNi_{y}Mn_{2-y-z}D_{z}O₄, wherein 0.9≤x≤1.1, 0.4≤y≤0.5, and 0.02≤z≤0.2, the precursors comprising Ni, Mn, Li and the dopant D, and

b) heating the precursors of step a) to a temperature of between 600° C. and 1000° C.

The temperature of step b) is preferably between 800° C. and 950° C., such as 900° C.

In an embodiment, the temperature of step b) and the duration in time of step b) are controlled so as to ensure uniform distribution of the dopant D throughout the lithium positive electrode material. For relatively short durations of time of step b) the temperature of step b) should be relatively higher, whilst for relatively long durations of time of step c) the temperature of step c) should be relatively lower. An example is that the temperature is about 750° C. and the duration of time is 4 hours.

The method of providing a lithium positive electrode active material is for example as described in the patent application WO17032789 A1.

In an embodiment of the process for preparing the lithium positive electrode active material, the precursors comprise both lithium carbonate and either nickel carbonate and manganese carbonate or nickel manganese carbonate. Thus, the precursors comprise lithium carbonate, nickel carbonate and manganese carbonate, or the precursors comprise lithium carbonate and nickel manganese carbonate. Alternatively, the precursors could comprise lithium carbonate, nickel manganese carbonate and either nickel or manganese carbonate.

Another aspect of the invention relates to a secondary battery comprising a positive electrode which comprises the lithium positive electrode active material according to the invention.

The invention has been illustrated by a description of various embodiments, figures, and examples. While these embodiments, figures, and examples have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

### SHORT DESCRIPTION OF THE FIGURES

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

FIG. 1 shows X-ray diffraction (XRD) pattern of an LMNO material doped with Co;

FIG. 2 shows elemental distribution of multiple secondary particles of a lithium positive electrode active material according to the invention;

FIG. 3 shows elemental mapping of a single primary particle from a lithium positive electrode active material according to the invention;

FIG. 4 shows two representative SEM images of a lithium positive electrode active material according to the invention;

FIG. 5 shows the effect of doping on stability for an undoped lithium positive electrode active material and similar but doped lithium positive electrode active materials according to the invention;

FIG. 6a shows the result of an electrochemical cycling test at 55° C. as described in Example 1;

FIG. 6b shows the discharge capacity of six doped lithium positive electrode active materials shown in FIG. 6a;

FIG. 7 shows voltage curves of 3^{rd} discharge at 0.2 C and 55° C. for reference and doped samples; and

FIG. 8 shows capacity between 4.4 V and 4.2 V during 3^{rd} discharge at 0.2 C and 55° C. for reference and doped samples.

FIG. 9a shows the relationship between circularity and degradation for four samples of a lithium positive electrode active material according to the invention and with substantially the same spinel stoichiometry;

FIG. 9b shows the relationship between roughness and degradation for four samples of a lithium positive electrode active material according to the invention and with substantially the same spinel stoichiometry;

FIG. 9c shows the relationship between average diameter and degradation for four samples of a lithium positive electrode active material according to the invention and with substantially the same spinel stoichiometry;

FIG. 9d shows the relationship between aspect ratio and degradation for four samples of a lithium positive electrode active material according to the invention and with substantially the same spinel stoichiometry;

FIG. 9e shows the relationship between solidity and degradation for four samples of a lithium positive electrode active material according to the invention and with substantially the same spinel stoichiometry; and

FIG. 9f shows the relationship between porosity and degradation for four samples of a lithium positive electrode active material according to the invention and with substantially the same spinel stoichiometry.

### DETAILED DESCRIPTION OF THE FIGURES

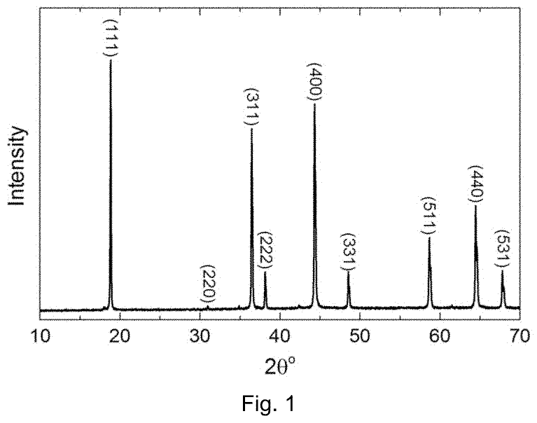

FIG. 1 shows an X-ray diffraction (XRD) pattern of a lithium positive electrode active material in the form of a LMNO material doped with Co. The sample has the composition Li_{0.96}Ni_{0.44}Mn_{1.47}Co_{0.09}O₄. Marked peaks refer to the spinel phase of the LMNO material. Rietveld refinement shows that the doped lithium positive electrode active material has 96 wt % spinel phase and a primary particle size of 220 nm.

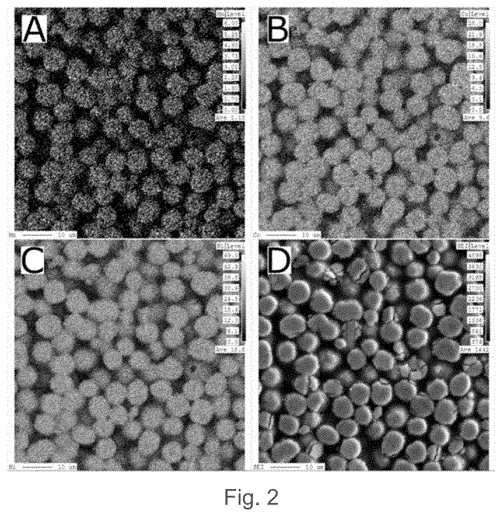

FIG. 2 shows elemental distribution of a lithium positive electrode active material according to the invention. The lithium positive electrode active material is a Co doped LMNO material having the nominal composition Li_{0.96}Ni_{0.44}Mn_{1.47}Co_{0.09}O₄. The pictures of FIG. 2 show elemental analysis by wavelength-dispersive X-ray spectroscopy so that FIG. 2a shows the distribution of Mn within the secondary particles. FIGS. 2b and 2c show the distribution of Co and Ni, respectively, within the secondary particles of the lithium positive electrode active material. FIG. 2d shows the secondary electron image. Prior to the x-ray spectroscopy, the lithium positive electrode active material has been embedded into an epoxy material and ground in order to reveal the inside of the lithium positive electrode material. From FIG. 2b it is clear that the dopant, in this case cobalt, is uniformly distributed inside the secondary particles of the lithium positive electrode active material.

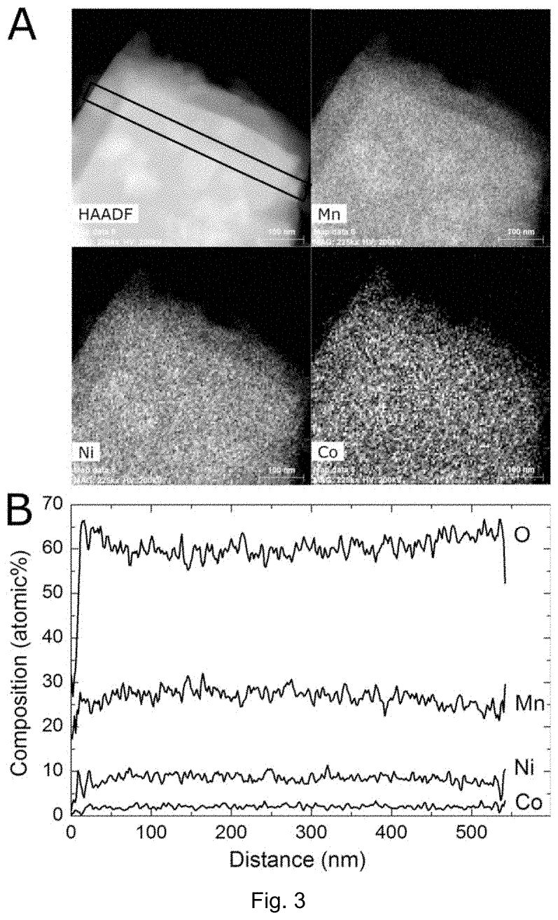

FIG. 3 shows elemental mapping of a single primary particle from a lithium positive electrode active material according to the invention. The mapping of elements across the single primary particle is STEM-EDS mapping. FIG. 3A has four individual images, where the image with the indication “HAADF” is a high-angle annular dark-field image of the primary particle, and the images with indication “Mn”, “Ni”, and “Co”, respectively, are mapping across the primary particles of manganese, nickel, and cobalt, respectively. The primary particle is of a lithium positive electrode active material composition Li_{0.96}Ni_{0.44}Mn_{1.47}Co_{0.09}O₄. From the Co map of FIG. 3A, it is clear that the dopant distribution, viz. the Co distribution, is uniform across the primary particle. This is also seen by the line profile of FIG. 3B. The line profile is measured along the path marked with two black lines in the HAADF map of FIG. 3A.

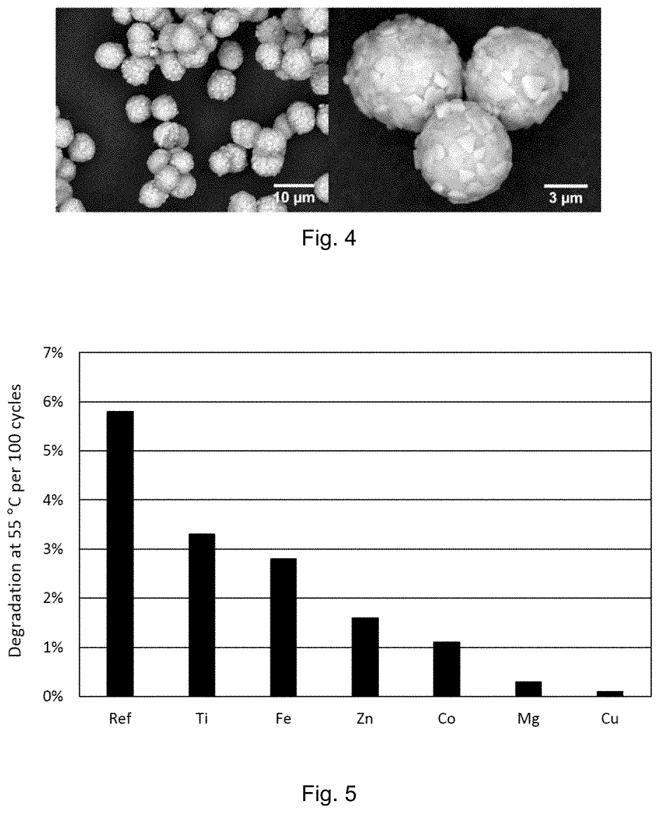

FIG. 4 shows two representative SEM images of a lithium positive electrode active material according to the invention. The lithium positive electrode active material has the composition Li_{0.96}Ni_{0.44}Mn_{1.47}Co_{0.09}O₄. FIG. 4 shows secondary particles of the material and it is seen from FIG. 4 that the secondary particles are spherical and have a diameter in the range from about 6 to about 10 μm. Primary particles are seen as the facetted objects in the surface of the secondary particles.

FIG. 5 shows the effect of doping on stability for an undoped lithium positive electrode active material and similar but doped lithium positive electrode active materials according to the invention. The effect of doping on stability is shown as the degradation after 100 cycles at 55° C. in 2032 type coin cell half cells. This is described more thoroughly in Example 1 below.

All doped LMNO materials shown in FIG. 5 have the nominal composition Li_{0.96}Ni_{0.44}Mn_{1.47}D_{0.09}O₄, where D is the dopant, viz. Co, Cu, Mg, Ti, Zn, or Fe. From FIG. 5 it is seen that each of the doped materials has a reduced degradation compared to the undoped material. Whilst Li_{0.96}Ni_{0.44}Mn_{1.47}Ti_{0.09}O₄ shows a 1 C degradation of about 3.3%, Fe shows 1 C degradation of less than 3%, Zn a 1 C degradation of less than 2%, Co a 1 C degradation of about 1%, whilst Mg and Cu have the lowest 1 C degradation, viz. of about 0.3% and 0.1%, respectively.

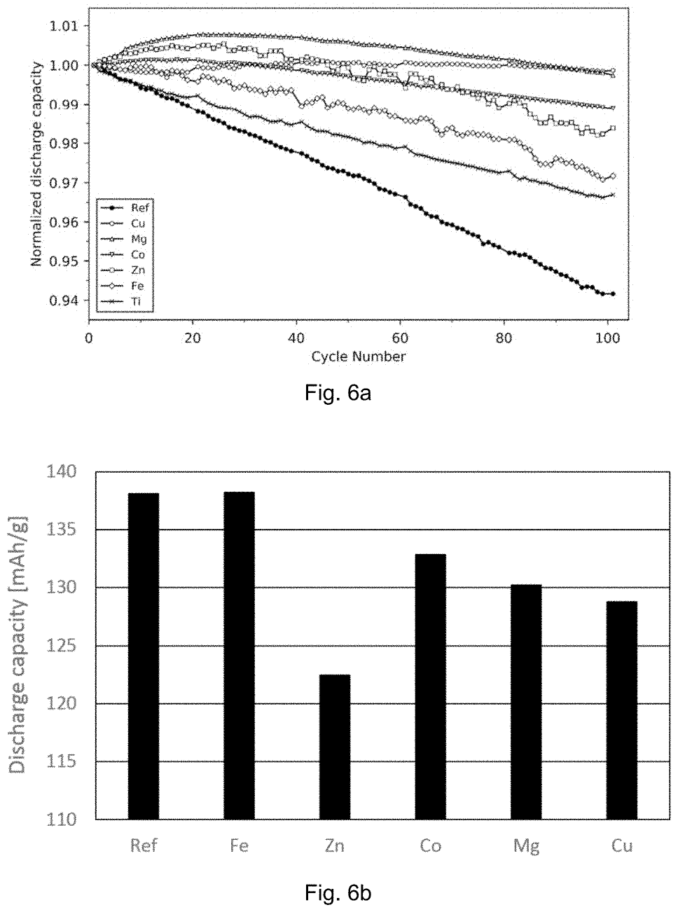

FIG. 6a shows the result of an electrochemical cycling test following an electrochemical power test (cycle 1 in the Figure corresponds to cycle 32 in Example 1) at 55° C. To ease comparison between the different samples, the discharge capacities have been normalized to 1 in the first 1 C cycle (cycle 2 in the graph). In FIG. 6a, a reference material and six lithium positive electrode active materials according to the invention and prepared as described in Example 2 have been tested. The lithium positive electrode active materials of the invention have a nominal composition of Li_{0.96}Ni_{0.44}Mn_{1.47}D_{0.09}O₄, where D is the dopant, viz. Co, Cu, Mg, Ti, Zn or Fe, whilst the reference material is the undoped lithium positive electrode active material described in Example 2, i.e. Li_{1.0}Ni_{0.46}Mn_{1.54}O₄.

It is seen from FIG. 6a that the six doped lithium positive electrode active materials have increased stability, in that the capacity of the lithium positive electrode active materials of the invention decrease by no more than 3.3% over 100 cycles between from 3.5 to 5.0 V at 55° C. as described in Example 1. This is significantly better than the stability of the reference material as shown in FIGS. 5 and 6a.

FIG. 6b shows the discharge capacity of six doped lithium positive electrode active materials shown in FIG. 6a. From FIG. 6b it can be seen that even though doping of the lithium positive electrode active material has benefits in relation to decreasing the degradation, this benefit may be accompanied by a lowering of the discharge capacity for some of the dopants. The choice of dopant and the amount thereof can be optimized in order to obtain a lithium positive electrode active material having both a high discharge capacity and a low degradation.

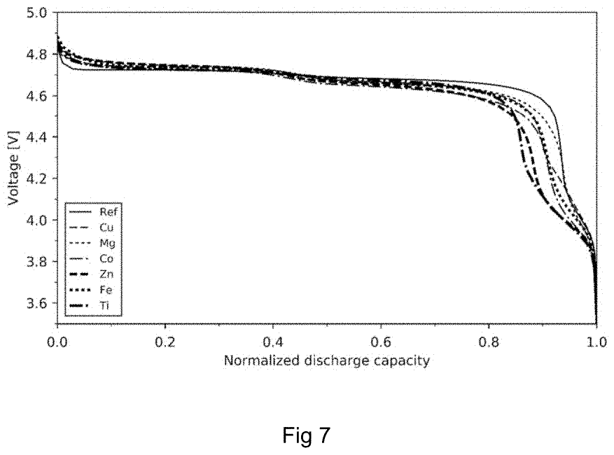

FIG. 7 shows voltage curves of 3^{rd} discharge at 0.2 C and 55° C. for a reference sample and for doped samples of the material according to the invention. The capacity is normalized to the total discharge capacity. Clear differences are seen, between the reference sample and the doped sample of a material according to the invention, in the final part of the discharge, where the voltage drops below 4.6 V. It is seen that all doped samples have a higher relative amount of capacity at voltage values below 4.6V compared to the reference sample.

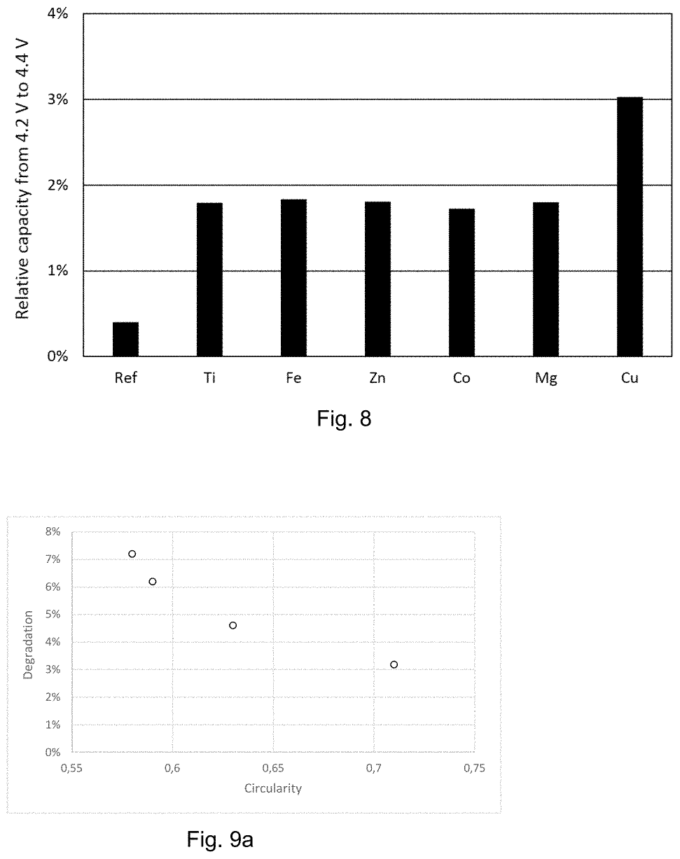

FIG. 8 shows capacity between 4.4 V and 4.2 V during 3^{rd} discharge at 0.2 C and 55° C. for a reference sample and for doped samples of the material according to the invention. This capacity between 4.4 V and 4.2 V during the discharge is a measure of the slope of the voltage curve when moving between Mn-redox activity around 4 V and Ni-redox activity around 4.7 V. A steep slope of this voltage curve, and thus small value of the capacity between 4.2 V and 4.4 V, seems to indicate a material with a relatively high degradation. It seems that a steep slope of the voltage curve correlates to a high strain which may give rise to an increase of the degradation of the material. This is especially the case at high discharge rates. Comparing with FIG. 5, it is supported that a high capacity between 4.2 V and 4.4 V decreases degradation.

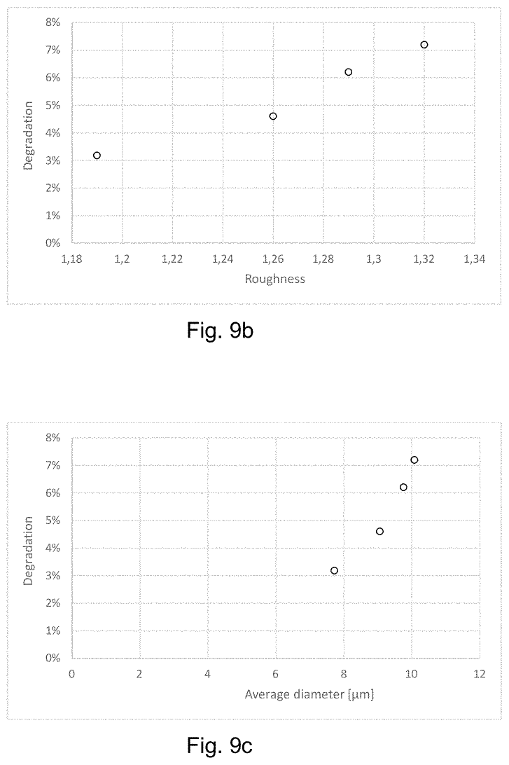

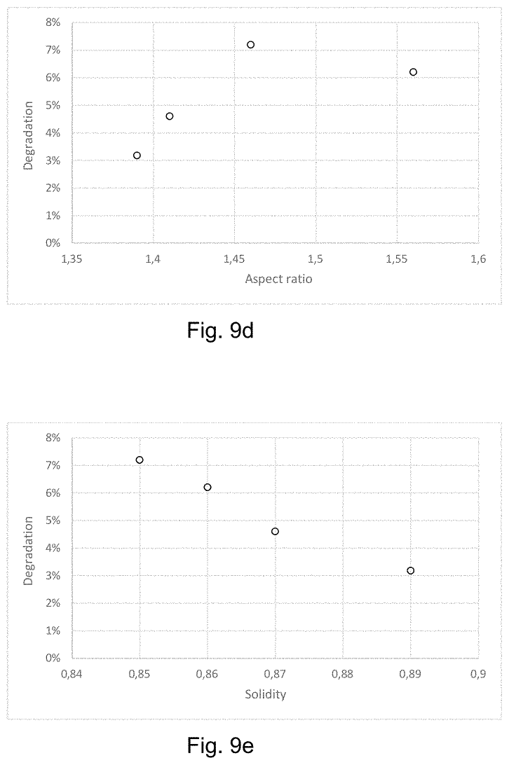

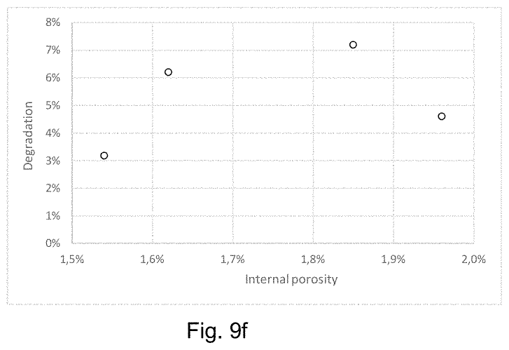

FIGS. 9a-9f show the relationship between degradation and a range of parameters for the four samples of lithium positive electrode active materials have differing degradations values, but very similar spinel stoichiometries. Of the four samples shown in FIG. 9a-9f, the spinel of three of the samples has the spinel stoichiometry LiNi_{0.454}Mn_{1.546}O₄, whilst the spinel of the fourth sample has the spinel stoichiometry LiNi_{0.449}Mn_{1.551}O₄. The four samples are all prepared based on co-precipitated precursors and the particles are secondary particles. Even though these four samples are non-doped, viz. z=0 in the formula LiₓNi_{y}Mn_{2-y-z}D_{z}O₄, the impact of circularity, roughness, average diameter, aspect ratio, solidity and internal porosity on degradation correspond is the same as the impact of these factors on a similar material with doping, viz. 0.02≤z≤0.2. However, the doping of the material further assists in decreasing the degradation.

FIG. 9a shows the relationship between circularity of secondary particles and degradation for four samples of a lithium positive electrode active material according to the invention and with substantially the same spinel stoichiometry. The circularity of a secondary particle is measured from the area and the perimeter of the particle shape as 4π*[Area]/[Perimeter]². Circularity describes both overall shape and surface roughness, where a higher value means more circular shape and smoother surface. A circle with a smooth surface has circularity 1. Average circularity is the arithmetic mean of the circularities of all secondary particles measured in a sample. Calculated using the software ImageJ (https://imagej.nih.gov). In FIG. 9a it is seen that higher value of circularity corresponds to lower degradation.

FIG. 9b shows the relationship between roughness of secondary particles and degradation for four samples of a lithium positive electrode active material according to the invention and with substantially the same spinel stoichiometry. The roughness of a secondary particle is measured as the ratio between the perimeter and the perimeter of an ellipse fitted to the particle shape. Roughness describes how rough the surface is, where a higher value means rougher surface. Average roughness is the arithmetic mean of the roughnesses of all secondary particles measured in a sample. Calculated using the software ImageJ (https://imagei.nih.gov). In FIG. 9b it is seen that lower value of roughness corresponds to lower degradation.

FIG. 9c shows the relationship between average diameter of secondary particles and degradation for four samples of a lithium positive electrode active material according to the invention and with substantially the same spinel stoichiometry. The diameter of a secondary particle is measured as the equivalent circle diameter, i.e. the diameter of a circle with the same area as the particle. Average diameter is the arithmetic mean of the diameters of all secondary particles measured in a sample. Calculated using the software ImageJ (https://imagej.nih.gov). In FIG. 9c it is seen that a lower average diameter to lower degradation. The average diameter of secondary particles is given in μm.

FIG. 9d shows the relationship between aspect ratio of secondary particles and degradation for four samples of a lithium positive electrode active material according to the invention and with substantially the same spinel stoichiometry. The aspect ratio of a secondary particle is measured from an ellipse fitted to the particle shape. The aspect ratio is defined as [Major axis]/[Minor Axis] where Major axis and Minor Axis are the major and minor axes of the fitted ellipse. Average aspect ratio is the arithmetic mean of the aspect ratios of all secondary particles measured in a sample. Calculated using the software ImageJ (https://imagei.nih.gov). In FIG. 9d it is seen that a lower aspect ratio in general corresponds to lower degradation.

FIG. 9e shows the relationship between solidity of secondary particles and degradation for four samples of a lithium positive electrode active material according to the invention and with substantially the same spinel stoichiometry. The solidity of a secondary particle is defined as the ratio between the particle area and the area of the convex area, i.e. [Area]/[Convex Area]. The convex area can be thought of as the shape resulting from wrapping a rubber band around the particle. The more concave features in a particle's surface, the higher is the convex area and the lower is the solidity. Average solidity is the arithmetic mean of the solidities of all secondary particles measured in a sample. Calculated using the software ImageJ (https://imagei.nih.gov). In FIG. 9e it is seen that higher values of solidity correspond to lower degradation.

FIG. 9f shows the relationship between porosity of secondary particles and degradation for four samples of a lithium positive electrode active material according to the invention and with substantially the same spinel stoichiometry. The porosity of a secondary particle is the percentage of the internal area that appears with dark contrast in the SEM image, where dark contrast is interpreted as a porosity, i.e. a hole inside the particle. Average porosity is the arithmetic mean of the porosities of all secondary particles measured in a sample. Calculated using the software ImageJ (https://imagei.nih.gov). In FIG. 9f it is seen that a lower value of porosity in general corresponds to lower degradation.

### EXAMPLES

### Example 1

Electrochemical tests have been realized in 2032 type coin cells, using thin composite positive electrodes of doped lithium positive electrode active material according to the invention and metallic lithium negative electrodes (half-cells). The thin composite positive electrodes were prepared by thoroughly mixing 84 wt % of lithium positive electrode active material (prepared as described in Example 2) with 8 wt % Super C65 carbon black (Timcal) and 8 wt % PVdF binder (polyvinylidene difluride, Sigma Aldrich) in NMP (N-methyl-pyrrolidone) to form a slurry. The slurry was spread onto a carbon coated aluminum foil using a doctor blade with a 160 μm gap and dried for 2 hours at 80° C. to form a film.

Electrodes with a diameter of 14 mm and a loading of approximately 7 mg of lithium positive electrode active material were cut from the dried film, pressed in a hydraulic pellet press (diameter 20 mm; 3 tonnes) and subjected to 10 hours drying at 120° C. under vacuum.

Coin cells were assembled in argon filled glove box (<1 ppm O₂ and H₂O) using two polymer separators (Toray V25EKD and Freudenberg FS2192-11SG) and 100 μL electrolyte containing 1 molar LiPF₆ in EC:DMC (1:1 in weight). Two 250 μm thick lithium disks were used as counter electrodes and the pressure in the cells were regulated with a stainless steel disk spacer and disk spring on the negative electrode side.

Electrochemical lithium insertion and extraction was monitored with an automatic cycling data recording system (Maccor) operating in galvanostatic mode. A power test was programmed to run the following cycles: 3 cycles 0.2 C/0.2 C (charge/discharge), 3 cycles 0.5 C/0.2 C, 5 cycles 0.5 C/0.5 C, 5 cycles 0.5 C/1 C, 5 cycles 0.5 C/2 C, 5 cycles 0.5 C/5 C, 5 cycles 0.5 C/10 C, and then 0.5 C/1 C cycles with a 0.2 C/0.2 C cycle every 20^{th} cycle. C-rates were calculated based on the theoretical specific capacity of the material of 148 mAhg⁻¹ so that e.g. 0.2 C corresponds to 29.6 mAg⁻¹ and 10 C corresponds to 1.48 Ag⁻¹. Degradation per 100 cycles is measured from after the power test, i.e. from cycle 33 to cycle 133.

### Example 2

Preparation of doped lithium positive electrode active material can be made by heating a lithium positive electrode active material, i.e. LiₓNi_{y}Mn_{2-y}O₄ (LNMO), with a dopant precursor. In this example, Li_{1.0}Ni_{0.46}Mn_{1.54}O₄ has been used as undoped starting material and DNO₃ has been used as dopant precursor, where D is the dopant, viz. Co, Cu, Mg, Ti, Zn, or Fe.

D-nitrate (e.g. CoNO₃) is dissolved 1:1 by weight in water and added to 20 g LNMO material in stoichiometric ratio in order to obtain an average composition of Li_{0.96}Ni_{0.44}Mn_{1.47}D_{0.09}O₄ in the doped lithium positive electrode active material. The slurry is dried at 80° C. and calcined at 700° C. 4 h.

1. A lithium positive electrode active material for a high voltage secondary battery, where the cathode is fully or partially operated above 4.4 V vs. Li/Li+, said lithium positive electrode active material comprising at least 95 wt % spinel having a chemical composition of LiₓNi_{y}Mn_{2-y-z}D_{z}O₄, wherein 0.9≤x≤1.1, 0.4≤y≤0.5, 0.02≤z≤0.2, wherein D is a dopant chosen between the following elements: Co, Cu, Ti, Zn, Mg, Fe or combinations thereof, wherein the lithium positive electrode active material is a powder composed of secondary particles formed by primary particles, wherein said lithium positive electrode active material has a tap density of at least 1.9 g/cm³.

2. A lithium positive electrode active material according to claim 1, wherein the dopant D is distributed substantially uniformly throughout the lithium positive electrode material.

3. A lithium positive electrode active material according to claim 1, wherein at least 90% of said dopant D is incorporated in the spinel of said lithium positive electrode material.

4. A lithium positive electrode active material according to claim 1, wherein 0.96≤x≤1.0 in the composition LiₓNi_{y}Mn_{2-y-z}D_{z}O₄.

5. A lithium positive electrode active material according to claim 1, wherein said lithium positive electrode active material is cation disordered.

6. A lithium positive electrode active material according to claim 1, wherein the BET surface area of the secondary particles is below 0.25 m²/g.

7. A lithium positive electrode active material according to claim 1, wherein the secondary particles are characterized by an average circularity higher than 0.55 and simultaneously an average aspect ratio lower than 1.60.

8. A lithium positive electrode active material according to claim 1, wherein D50 of the secondary particles is between 3 and 50 μm.

9. A lithium positive electrode active material according to claim 8, wherein the distribution of the agglomerate size of the secondary particles is characterized in that the ratio between D90 and D10 is smaller than or equal to 4.

10. A lithium positive electrode active material according to claim 1, wherein the diameter or the volume equivalent diameter of the primary particles larger than D5 is between 100 nm and 2 μm and where the diameter or the volume equivalent diameter of the secondary particles is between 1 μm and 25 μm.

11. A lithium positive electrode active material according to claim 1, wherein at least 90% of the dopant D is part of the spinel.

12. A lithium positive electrode active material according to claim 1, the capacity of the lithium positive electrode active material is above 120 mAh/g.

13. A lithium positive electrode active material according to claim 1, wherein the separation between the two Ni-plateaus around 4.7 V of the lithium positive electrode active material is at least 50 mV.

14. A process for preparing a lithium positive electrode active material comprising at least 95 wt % spinel having a chemical composition of LiₓNi_{y}Mn_{2-y-z}D_{z}O₄, wherein 0.9≤x≤1.1, 0.4≤y≤0.5, and 0.02≤z≤0.2 wherein D is a dopant chosen between the following elements: Co, Cu, Ti, Zn, Mg, Fe or combinations thereof, wherein the lithium positive electrode active material is composed of particles, wherein said lithium positive electrode active material has a tap density of at least 1.9 g/cm³ and wherein said lithium positive electrode active material comprises at least 95 wt % spinel phase, said process comprising the steps of:
a) providing a lithium positive electrode active material comprising at least 95 wt % spinel having a chemical composition of LiₓNi_{y}Mn_{2-y}O₄, wherein 0.9≤x≤1.1, 0.4≤y≤0.5,
b) mixing the lithium positive electrode active material of step a) with a dopant precursor of the dopant D,
c) heating the mixture of step b) to a temperature of between 600° C. and 1000° C.

15. A process for preparing a lithium positive electrode active material comprising at least 95 wt % spinel having a chemical composition of LiₓNi_{y}Mn_{2-y-z}D_{z}O₄, wherein 0.9≤x≤1.1, 0.4≤y≤0.5, and 0.02≤z≤0.2, wherein D is a dopant chosen between the following elements: Co, Cu, Ti, Zn, Mg, Fe or combinations thereof, wherein the lithium positive electrode active material is composed of particles, wherein said lithium positive electrode active material has a tap density of at least 1.9 g/cm³ and wherein said lithium positive electrode active material comprises at least 95 wt % spinel phase, said process comprising the steps of:
a) providing precursors for preparing a lithium positive electrode active material comprising at least 95 wt % spinel having a chemical composition of LiₓNi_{y}Mn_{2-y-z}D_{z}O₄, wherein 0.9≤x≤1.1, 0.4≤y≤0.5, and 0.02≤z≤0.2, said precursors comprising Ni, Mn, Li and the dopant D, and
b) heating the precursors of step a) to a temperature of between 600° C. and 1000° C.

16. A method according to claim 15, wherein the precursors comprise both lithium carbonate and either nickel carbonate and manganese carbonate or nickel manganese carbonate.

17. A secondary battery comprising a positive electrode which comprises the lithium positive electrode active material according to claim 1.
